(19) United States
(12) Patent Application Publication
(10) Pub. No.: US 2026/0054402 A1
(43) Pub. Date: Feb. 26, 2026

(54) Hydrocarbon Polymer Coating Material for a Razor Blade and the Method of Coating

(71) Applicant: The Gillette Company LLC, Boston, MA (US)

(72) Inventors: Derek Michael Smith, Arlington, MA (US); Kenneth James Skrobis, Maynard, MA (US); Jonathan Raymond Petrie, Braintree, MA (US); Emily Charlotte Boswell, Wyoming, OH (US); Allen Chu Chang, Middleton, MA (US); Jason Scott Slattery, Malden, MA (US)

(21) Appl. No.: 19/307,264

(22) Filed: Aug. 22, 2025

Related U.S. Application Data
(60) Provisional application No. 63/685,750, filed on Aug. 22, 2024.
(60) Provisional application No. 63/867,822, filed on Aug. 21, 2025.

(51) Int. Cl. B26B 21/60; C09D 123/06

(52) U.S. Cl. CPC B26B 21/60; C09D 123/06

(57) ABSTRACT

A razor blade with a sharpened cutting edge with an outer bonding surface. A hydrocarbon polymer organic coating material deposited on the outer bonding surface forming an outermost layer of the sharpened cutting edge. The hydrocarbon polymer organic coating is composed of one or more layers. Additionally, the method of coating the cutting edge is described.

### FIELD OF THE INVENTION

The present invention relates generally to coating of substrates, and more particularly to improved coatings on razor components, such as razor blades.

### BACKGROUND OF THE INVENTION

Typical razor blades used for shaving are commonly created by grinding a sharp bevel onto a martensitic steel substrate. A hard coating is often applied to strengthen the blade edge and to create a tip shape appropriate for shaving. In addition to the hard coating, one may apply an outer coating that may improve the shaving experience by reducing the cut force in comparison to the uncoated blade edge.

Due to evolving technology in terms of blade edges, there is an ever existing need to improve upon coatings that may work in synergy with the blade edge. As such, there is a need for improved coatings on cutting edges, such as blade edges, that exhibit desirable characteristics (e.g., cutting force, surface energy, minimal nicking of the skin, etc.) for uses such as hair cutting and minimize potential damage to the substrate, e.g. mechanical damage, and lubricous coating wear, and that utilize cost-effective and time-effective manufacturing processes.

### SUMMARY OF THE INVENTION

Razor blades described herein may comprise a sharpened cutting edge with an outermost layer created by deposition of a lubricious, hydrocarbon polymer coating material in one or more layers. An outer surface of the sharpened cutting edge may be coated and/or treated, such that bonding of the organic coating material is facilitated and/or optimized, ensuring it survives during shaving.

In accordance with an aspect of the present disclosure, a razor blade has a sharpened cutting edge with an outer bonding surface. A hydrocarbon polymer coating material deposited on the outer bonding surface forming an outermost layer of the sharpened cutting edge. The hydrocarbon polymer coating comprises a polymer coating applied to achieve both durability and low cut forces.

Additionally, a method of depositing a hydrocarbon polymer layer onto the outer layer of a substrate is described. The method includes providing a substrate, depositing a hydrocarbon polymer layer onto the substrate to create a coated substrate, and curing the hydrocarbon polymer layer on the coated substrate. The hydrocarbon polymer may be cured to exhibit at least 10% crystallinity.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a side view of a razor blade with a symmetric substrate, in accordance with the present disclosure.

FIG. 2 is a perspective view of a tip portion of another razor blade with a symmetric substrate, in accordance with the present disclosure.

FIG. 3 is a side view of a razor blade with a symmetric substrate and a coating material on a tip portion, accordance with the present disclosure.

FIG. 4 is a side view of a razor blade with a symmetric substrate and a coating material on the tip portion and a section of a body portion, in accordance with the present disclosure.

FIG. 5 is a detailed view of a tip portion of a razor blade with a multi-layer coating material, in accordance with the present disclosure.

FIG. 6 is a side view of a tip portion of a further razor blade with a symmetric substrate and an asymmetric coating material, in accordance with the present disclosure.

FIG. 7A is a side view of a razor blade with an asymmetric substrate and a coating material, in accordance with the present disclosure.

FIG. 7B is a side view another razor blade with an asymmetric substrate and an asymmetric coating, in accordance with the present disclosure.

FIG. 8 is a diagrammatic view illustrating a tip region of a razor blade, in accordance with the present disclosure.

### DETAILED DESCRIPTION OF THE INVENTION

For purposes of the following detailed description, it is to be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the use of the singular includes the plural and plural encompasses singular, unless specifically stated otherwise. In addition, in this application, the use of “or” means “and/or” unless specifically stated otherwise, even though “and/or” may be explicitly used in certain instances.

As used herein, the term “coating” means a covering, including a monolayer, a free film, an impregnation, or the like, that is applied to an object or substrate, such that the covering may be continuous, contiguous, discontinuous, may have a single or varying thicknesses, or may exist in a single or multiple planes.

As used herein, a “substrate” may signify the substance or material acted upon by the deposition process(es) in the present disclosure. Nonlimiting examples of a substrate include a metal, an alloy, or a ceramic, such as chromium, platinum, boron, chromium diboride, titanium, titanium diboride, sand, limestone, glass, glass composites, silicate, silicate composites, vanadium, aluminum, silicon, tin, tantalum, zirconium, niobium, magnesium, manganese, iron, cobalt, copper, silver, zinc, hafnium, tungsten, molybdenum, or nickel, and oxides, nitrides, and oxynitrides thereof. A substrate may exhibit uniform widths along a length or may vary in width such as an undulating blade.

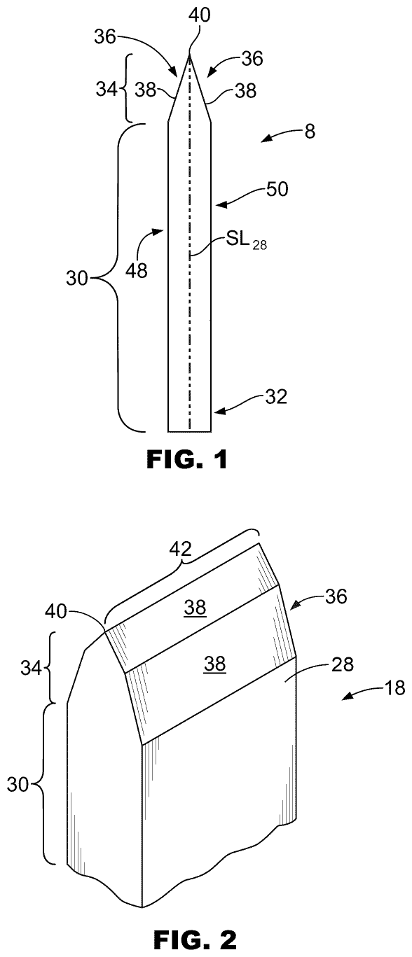

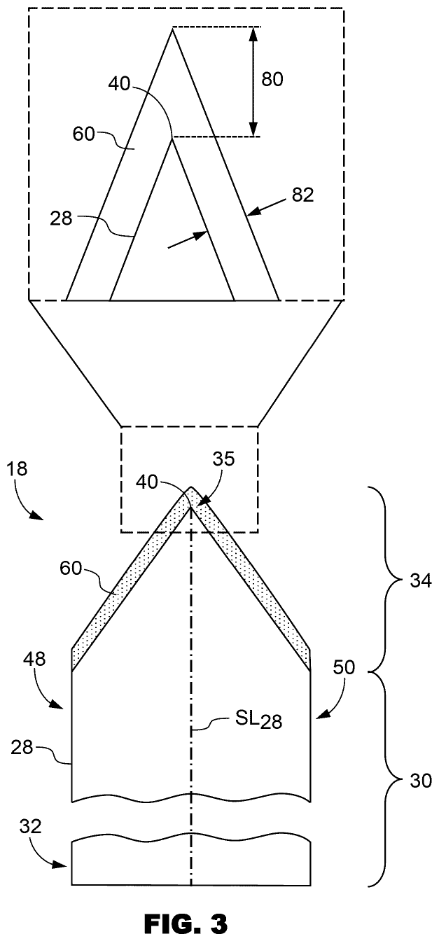

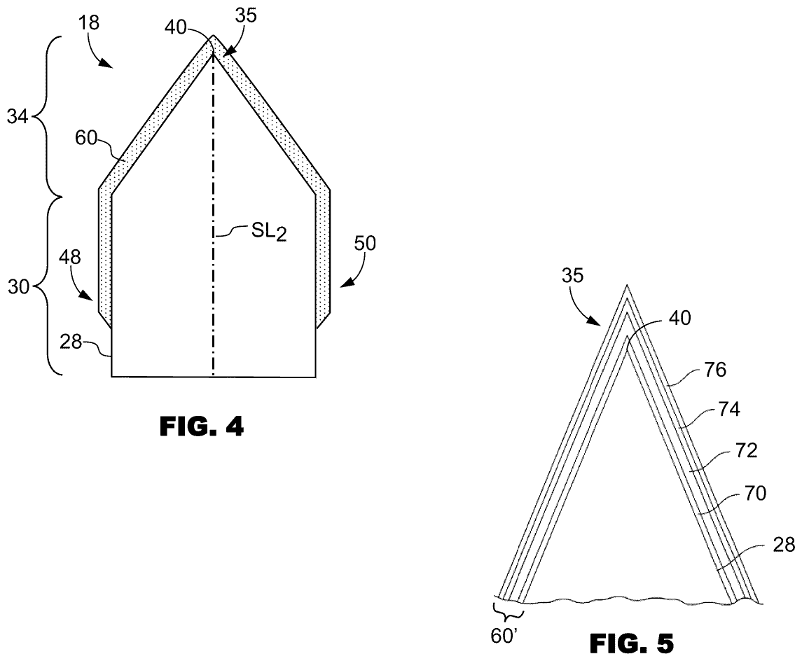

Referring now to the Figures, FIGS. 1, 3, and 4 are side views of a cutting member 8 (here, a razor blade) in accordance with aspects of the present disclosure, and FIG. 2 is a detailed perspective view of elements of a cutting member 18 (here, a razor blade) in accordance with aspects of the present disclosure. The razor blades 8 and 18 shown in FIGS. 1-4 may each comprise a substrate 28 and a coating 60 (not visible in FIGS. 1 and 2; see FIGS. 3 and 4) comprising a coating polymer layer comprising hydrocarbons. The razor blades 8 and 18 may comprise a first portion with a blade body 30 and a second portion with a tip portion 34. The blade body 30 may comprise a base 32, and the tip portion 34 may comprise flanks 36 that converge at a sharpened tip 40 to define a sharpened cutting edge 42, which performs the cutting of hair. The flanks 36 may each comprise one or more bevels or facets 38. The substrate 28 of FIG. 2 is described in more detail in U.S. Pat. No. 9,751,230. The razor blades 8 and 18 may be incorporated into a razor cartridge (not shown).

The cutting member may be a disposable razor that may be one as described in, e.g. U.S. Design No. D650,947, D707,119, D707,135, D931,535, D766,506, D730,578, D741,009, D741,008 and D741,546 or as a combination thereof. The cartridge may be one as described in e.g. U.S. Pat. Nos. 7,247,249, 7,669,335, and 9,193,077 or as a combination thereof. The powered razor may be one as described in e.g. U.S. Pat. Nos. 7,197,825, 7,669,335, 7,694,419, 8,037,608, 9,073,226 or as a combination thereof. The razor may be one as described in e.g. U.S. Pat. Nos. 8,745,882, 8,745,883, 8,978,258, 8,209,867, 8,250,763, 9,193,077, 9,233,477, 9,248,579, 9,713,878 and U.S. Design No. D712,248 or as a combination thereof. The powered razor may be one as described in e.g. U.S. Pat. No. 9,079,321, or as a combination thereof. The cartridge may be one as described in e.g. U.S. Pat. Nos. 8,209,867, 9,079,321, and 9,278,579 or as a combination thereof. The razor may be one as described in e.g. U.S. Pat. Nos. 8,281,491, 10,377,052, U.S. Design No. D831,375, U.S. Pat. Nos. 9,193,077, 9,333,658, 9,511,501 and U.S. Design No. D811,658.

The razor may be one as described in e.g. U.S. Design No. D695,960, U.S. Design No. D695,544, U.S. Design No. D695,545, U.S. Design No. D694,469, U.S. Design No. D694,470, US Design No. D694,471, U.S. Design No. D699,473, U.S. Design No. D724,269, U.S. Design No. D724,270, U.S. Design No. D725,824 and U.S. Design No. D796,544.

In the example illustrated in FIGS. 1-4, the substrate 28, specifically the tip portion 34, is substantially symmetric and may comprise a split line SL₂₈ that passes through the tip 40 and divides or separates the substrate 28 into substantially equal first and second sections or halves (not labeled). The split line SL₂₈ may coincide with a centerline (not shown) of the coating 60, as described herein, such that the split line SL₂₈ may also divide or separate the coating 60 into substantially equal first and second sections or halves. The split line SL₂₈ may be generally parallel with generally planar, outer surfaces (not labeled) of the blade body 30. One outer side 48 (also referred to herein as a first outer side) of the substrate 28 is disposed opposite the split line SL₂₈ with respect to the other outer side 50 (also referred to herein as a second outer side). As used herein, the terms “first” and “second” (i.e., to designate structures such as sections) are for reference only and are not intended to be limiting.

At least a portion of one outer side of the substrate 28, e.g., the first outer side 48, may define a skin-contacting surface, and at least a portion of the other outer side, e.g., the second outer side 50, may define a hair-cutting surface. The two sides of the razor blade 8 and 18 may generally perform different functions (e.g., a bottom side that contacts the skin and a top side that performs cutting of the hair, in which both sides perform cutting of the hair with the top side (e.g., away from the skin) having a larger influence).

As shown in FIGS. 3 and 4, the razor blades 8 and 18 may comprise the coating 60 disposed substantially on at least a portion of the first outer side 48 and the second outer side 50 of the substrate 28. The coating 60 may comprise a single layer, as shown in FIGS. 3 and 4, or may comprise two or more layers (see FIG. 5). As used herein, the term “coating” means a covering, including a monolayer, a free film, an impregnation, or the like, that is applied to an object or substrate, such that the covering may be continuous, discontinuous, may have a single or varying thicknesses, or may exist in a single or multiple planes. The coating 60 may include one or more layers, in which each layer comprises one or more materials.

In the example shown in FIGS. 3 and 4, the coating 60 is depicted as extending along the first outer side 48 and the second outer side 50 of the substrate 28 from the tip region 35 toward the base 32. In some examples, the coating 60 may stop short of the blade body 30 and/or the base 32, and in some particular examples, the coating 60 may be disposed substantially only on the tip portion 34 of the substrate 28, for example as shown in FIG. 3. In other examples, the coating 60 may be disposed on the tip portion 34 of the substrate 28 and at least a portion of the blade body 30, for example as shown in FIG. 4. Coating of the blade body 30 may allow for easier rinsing and debris removal, which may allow for less use of water during cartridge rinsing and cleaning and may result in a cleaner, more aesthetic shaving cartridge over the life of the product. In some particular examples (not shown), the coating 60 may extend from the tip region 35 all the way to the base 32. In some aspects (not shown), the coating 60 may be disposed only on the first outer side 48 or the second outer side 50. In other aspects (not shown), the coating 60 may be disposed on the first and second outer sides 48 and 50, but may extend different distances along the first and second outer sides 48 and 50.

FIG. 5 provides a detailed view of a tip region 35 of a substrate 28 with a multi-layer coating 60′. The coating 60′ comprises of a polymer layer comprising hydrocarbons. As shown, the coating 60′ comprises two or more layers, including one or more of an interlayer 70, a hard coating layer 72, an overcoat layer 74, and an outer layer 76.

The interlayer 70 may be used to facilitate bonding of the hard coating layer 72 to the substrate 28. Examples of suitable materials for the interlayer 70 may include niobium, titanium, and chromium-containing material(s). A particular interlayer is made of niobium greater than about 100 angstroms and preferably up to about 500 angstroms thick. In some examples, the interlayer 70 may have a thickness from about 150 angstroms to about 350 angstroms.

The hard coating layer 72 may provide improved strength, corrosion resistance, and shaving ability and may be used to obtain a desired tip shape. The hard coating layer 72 may be made from fine-, micro-, or nano-crystalline carbon-containing materials (e.g., diamond, amorphous diamond, graphene, or diamond-like-carbon (DLC)), nitrides (e.g., boron nitride, niobium nitride, chromium nitride, zirconium nitride, or titanium nitride), carbides (e.g., silicon carbide), oxides (e.g., alumina, zirconia) or ceramic materials (including nanolayers or nanocomposites). The carbon-containing materials may be doped with other elements, such as tungsten, titanium, silver, or chromium by including these additives, for example, in the target during application by sputtering. The materials may also incorporate hydrogen, e.g., hydrogenated DLC. Preferably, the hard coating layer 72 is made of diamond, amorphous diamond, or DLC. A particular example includes DLC up to about 3,000 angstroms thick, preferably from about 500 angstroms to about 1,500 angstroms thick. DLC layers and methods of deposition are described in U.S. Pat. No. 5,232,568. As described in the “Handbook of Physical Vapor Deposition (PVD) Processing,” “DLC is an amorphous carbon material that exhibits many of the desirable properties of diamond but does not have the crystalline structure of diamond.”

The overcoat layer 74 may optionally be used to reduce tip rounding of the hard coated edge and to facilitate bonding of the outer layer 76 to the hard coating layer 72, while still maintaining the benefits of both. The overcoat layer 74 is preferably made of a chromium-containing material, e.g., chromium or chromium alloys or chromium compounds that are compatible with the hard coating layer 72 and the outer layer 76, e.g., CrPt., or other materials including Al, Zr, and Ti. (any others to include?) A particular overcoat layer 74 is chromium about 100-200 angstroms thick. The overcoat layer 74 may comprise material(s) similar to the interlayer 70 and/or the hard coating layer 72, such as niobium or boron. In some examples, the overcoat layer 74 may have a thickness of from about 50 angstroms to about 500 angstroms, preferably from about 100 angstroms to about 300 angstroms.

The outer layer 76 may be used to, for example, provide reduced friction. The outer layer 76 is a polymer layer comprising hydrocarbons that may further comprise surfactants either in the coating under certain curing conditions, or as part of the coating. The hydrocarbon polymer layer is selected from the group comprising of high density polyethylene, low density polyethylene, and mixtures thereof.

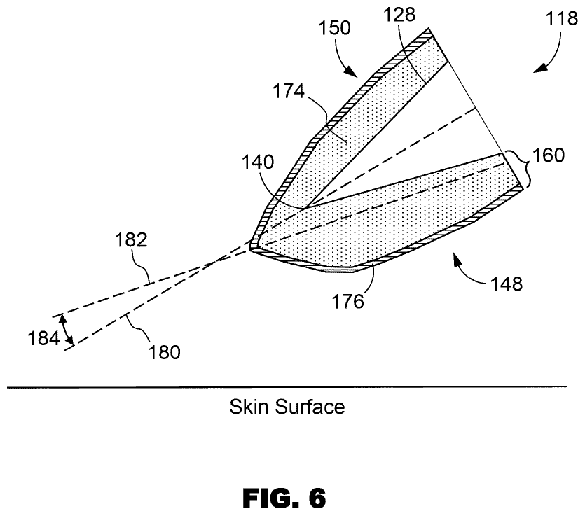

In the examples shown in FIGS. 3-5, the coatings 60 and 60′ may generally conform to and/or mirror an outer shape of underlying portions of the substrate 28 and may comprise a substantially uniform thickness. FIG. 6 illustrates an example of a coating 160 that does not conform to and/or mirror an outer shape of underlying portions of a substrate 128 (referred to herein as an asymmetric coating). The asymmetric coating 160 may comprise a variable thickness that varies along at least a portion of the substrate 128. The asymmetric coating 160 may comprise at least an outermost layer 176, which may comprise the hydrocarbon polymer coating material as described herein, and, optionally, one or more additional layers 174, which may comprise one or more of layers 70, 72, and 74 in FIG. 5.

The coatings may be symmetric or asymmetric along a split line as described below and as found in U.S. Pat. No. 11,759,962. The substrate 128 in FIG. 6 may comprise a split line 180 (also referred to as a centerline) that passes through a tip 140 and divides or separates the substrate 128 into substantially equal first and second sections or halves (not labeled). The centerline 180 may be generally parallel with generally planar, outer surfaces of a blade body (not shown; see FIGS. 1-4). The asymmetric coating 160 (including the outermost layer 176) may comprise a centerline 182 that may be offset from the centerline 180 of the substrate 128, as indicated by 184. The asymmetric coating 160 may be deposited on the substrate 128 at an angle with respect to the centerline 180 of the substrate 128, with the centerline 182 of the asymmetric coating 160 being determined by, for example, the angle at which the asymmetric coating 160 is deposited. In some examples, the centerline 182 of the asymmetric coating 160 may be offset from the centerline 180 of the substrate 128 by at least at least 3 degrees, and in other examples, by at least 5 degrees, by at least 8 degrees, or by at least 10 degrees. In all examples, the centerlines 180 and 182 may be offset by up to 30 degrees. The substrate 128 and asymmetric coating 160 in FIG. 6 are illustrated with respect to a skin surface. As described herein, a first outer side 148 of the substrate 128 may define a skin-contacting surface, and at least a portion of the other outer side, e.g., a second outer side 150, may define a hair-cutting surface. The asymmetric coating 160, particularly when the outermost layer 176 comprises the hydrocarbon polymer coating material described herein, may help to increase shaving comfort and safety by reducing cutting forces and improving skin management and may also help to increase durability by reducing shear forces and wear on critical surfaces attributed to peak cutting force of hair (i.e., the hair-cutting surface).

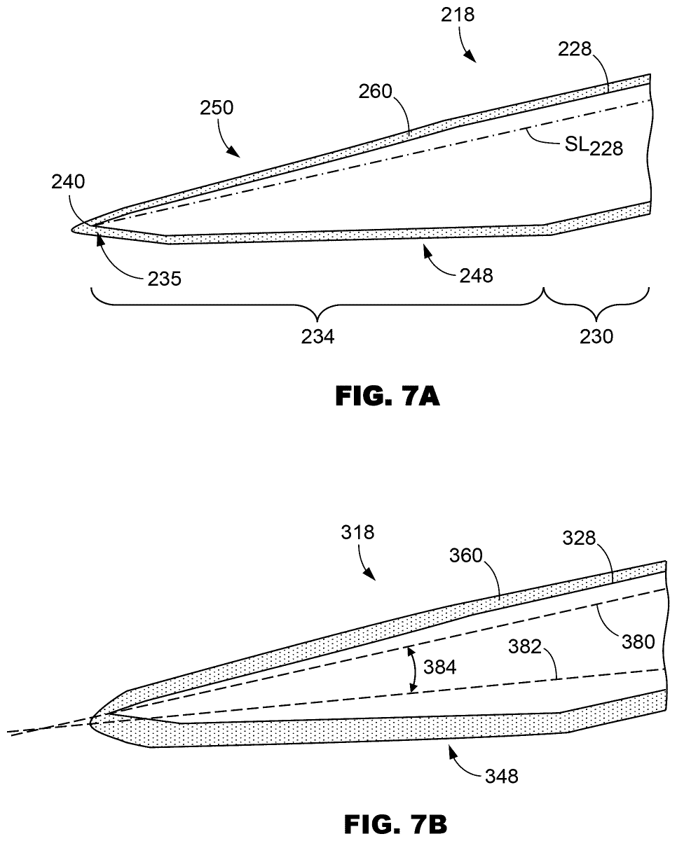

FIGS. 7A and 7B illustrate examples of a cutting member 218 and 318 (here, a razor blade) that comprises an asymmetric substrate 228 and 328. With reference to FIG. 7A, the razor blade 218 may comprise a first portion with a blade body 230 and a second portion with a tip portion 234, in which the blade body may comprise a base (not shown) and the tip portion 234 may comprise flanks (not labeled) that converge at a sharpened tip 240. The flanks may each comprise one or more bevels or facets (not labeled) that are of unequal length, such that the tip portion 234 is asymmetric. Although the tip portion 234 is depicted as including two facets on each of a first outer side 248 and a second outer side 250, it may be understood that the first and second outer sides 248 and 250 may comprise differing numbers of facets, and in some examples, one of the outer sides, e.g., the second outer side 250, may comprise no facets.

The razor blade 218 may comprise a coating 260 extending along the first and second outer sides 248 and 250 from a tip region 235 toward the base (not shown). As described herein, the first outer side 248 may define a skin-contacting surface, and the second outer side 250 may define a hair-cutting surface. Also as described herein, the coating 260 may be disposed on the tip portion 234 and at least a portion of the blade body 230, as shown in FIG. 7A, or only on the tip portion 234 (not shown; see FIG. 3). Although a single layer is depicted for convenience, the coating 260 may comprise an outermost layer and at least one additional layer, as described herein (see FIGS. 5 and 6).

With continued reference to FIG. 7A, the coating 260 may generally conform to and/or mirror an outer shape of underlying portions of the substrate 228 and may comprise a substantially uniform thickness. A split line SL₂₂₈ may pass through the sharpened tip 240 and may be generally parallel with outer surfaces (not labeled) of the blade body 230. Because the coating 260 generally conforms to an outer shape of the substrate 228, the split line SL₂₂₈ of the substrate 228 may coincide with a centerline (not shown) of the coating 260, as described herein.

With reference to FIG. 7B, the substrate 328 may be substantially similar to the substrate 228 in FIG. 7A except that the coating 360 is asymmetric, i.e., the coating 360 does not conform to and/or mirror an outer shape of underlying portions of the substrate 328. The asymmetric coating 360 may comprise a variable thickness that varies along at least a portion of the substrate 328. The substrate 328 may comprise a split line 380 (also referred to as a centerline) that may be substantially similar to the split line SL₂₂₈ shown in FIG. 7A. The asymmetric coating 360 may comprise a centerline 382 that may be offset from the centerline 380 of the substrate 328, as indicated by 384. As described above, the centerline 382 of the asymmetric coating 360 may be determined by an angle at which the asymmetric coating 360 is deposited with respect to the centerline 380 of the substrate 328. In some examples, the centerline 382 of the asymmetric coating 360 may be offset from the centerline 380 of the substrate 328 by at least at least 3 degrees, and in other examples, by at least 8 degrees. In further examples, the centerlines 380 and 382 may be offset by up to 30 degrees. As described above, the asymmetric coating 360, particularly when an outermost layer (not shown) comprises a hydrocarbon polymer coating material as described herein, may help to increase shaving comfort and safety, as well as durability.

In accordance with the present disclosure, a cutting member is provided, which may include the razor blades 8, 18, 118, and 218 of FIGS. 1-6, 7A, and 7B. The razor blade may comprise a substrate with a sharpened cutting edge and a coating material deposited on the substrate, specifically on the sharpened cutting edge and/or on the body, in which the coating material forms an outermost layer of the razor blade. The coating material may be adhered directly or indirectly to the substrate. The coating material may be deposited as a matrix layer in combination with one or more SAMs and additional matrix layers.

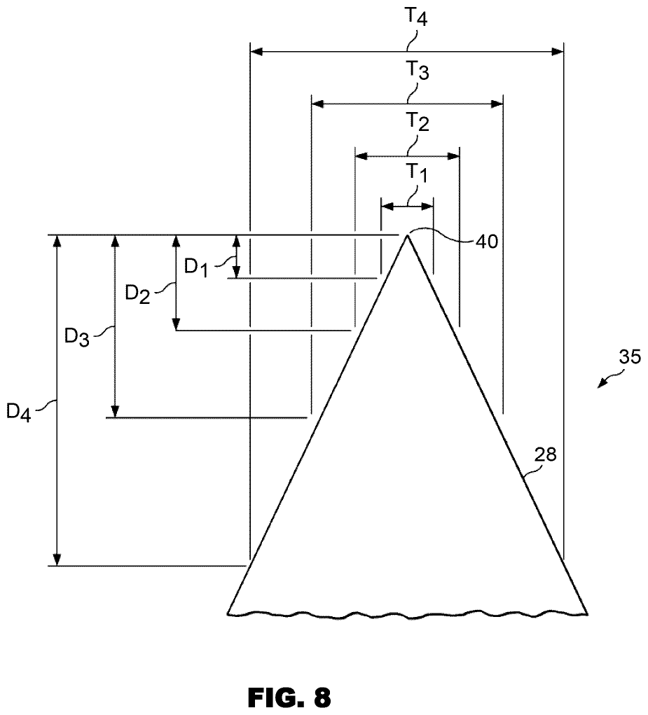

With reference to FIG. 8, the substrate 28 may comprise a thickness T₁ of between about 1.3 and 2.0 micrometers measured at a distance D₁ of four micrometers from the sharpened tip 40, a thickness T₂ of between about 2.3 and 3.5 micrometers measured at a distance D2 of eight micrometers from the sharpened tip 40, a thickness T₃ of between about 3.8 and 6.4 micrometers measured at a distance D3 of sixteen micrometers from the sharpened tip 40, and/or a thickness T₄ of between about 9.3 and 16.2 micrometers measured at a distance D4 of forty micrometers from the sharpened tip 40. Alternatively, or in addition, the substrate 28 may comprise a ratio of thickness T₁ measured at four micrometers to the thickness T₂ measured at eight micrometers of at least 0.55, and/or a ratio of thickness T₁ measured at four micrometers to the thickness T₃ measured at sixteen micrometers of at least 0.28. The substrate may exhibit a thickness of between 1 and 2 micrometers at a distance of 5 micrometers from the tip, between 2 and 10 micrometers at a distance of 10 micrometers from the tip, between 2 and 10 micrometers at a distance of 20 micrometers from the tip, between 5 and 15 micrometers at a distance of 30 micrometers from the tip, between 5 and 15 micrometers at a distance of 40 micrometers from the tip, between 7.5 and 20 micrometers at a distance of 50 micrometers from the tip, between 15 and 30 micrometers at a distance of 100 micrometers from the tip, between 20 and 45 micrometers at a distance of 150 micrometers from the tip, between 25 and 55 micrometers at a distance of 200 micrometers from the tip, between 45 and 65 micrometers at a distance of 250 micrometers from the tip, between 50 and 75 micrometers at a distance of 300 micrometers from the tip, between 55 and 100 micrometers at a distance of 350 micrometers from the tip, between 55 and 100 micrometers at a distance of 400 micrometers from the tip. In an embodiment, the ratio of thickness for the distance of 10 and 100 micrometers from the tip is between 1:15 to 2:3.

The substrate may have more than one facet such as two facets, three facets, four facets each having an included angle. In an embodiment, the substrate may have three or more pairs of facets; each pair of facets having an included angle. In an embodiment, the substrate may have pairs of facets forming the following included angles: 14-25 degrees by the two facets closest to the tip, an included angle of 12-19 by the facets adjacent to those closest to the tip followed by an included angle of 4-12. If the substrate only has two pairs of facets, then the included angles may be 14-25 by the facets closest to the tip followed by an included angle of 4-12 by the adjacent facets. Due to grinding, facets may be continuously grounded or may be distinct.

The substrate, including the sharpened cutting edge, may comprise a metal, an alloy, or a ceramic, e.g., stainless steel. In some examples, the substrate, specifically the sharpened cutting edge, may comprise one or more of the following materials, e.g., as at least one additional layer of material disposed between the sharpened cutting edge and the hydrocarbon polymer coating material (see FIGS. 5 and 6): (i) diamond, amorphous diamond, or diamond-like-carbon (DLC); or (ii) chromium, platinum, boron, chromium diboride, titanium, titanium diboride, vanadium, aluminum, silicon, tin, tantalum, zirconium, niobium, magnesium, manganese, iron, cobalt, copper, silver, zinc, hafnium, tungsten, molybdenum, or nickel, and oxides, nitrides, and oxynitrides thereof. In one example, the one or more additional layers of material may comprise chromium. In one particular example, the additional layers may comprise a layer of niobium, a layer of DLC, a layer of chromium, and an outermost layer comprising a hydrocarbon polymer coating material, as described herein. In another example, the one or more additional layers of material may comprise boron, including a metal boride such as chromium diboride, a metal boride alloy, or a boron-rich mixture or alloy. As used herein, the term “boron-rich” may refer to a material containing at least 50 atomic % boron. In one particular example, the additional layers may comprise a layer of niobium, a layer of DLC, a layer of boron or a boron-rich material, and an outermost layer comprising a hydrocarbon polymer coating material, as described herein.

It has now been discovered that by providing on the cutting edge of a safety razor blade a thin layer or coating comprising a solid hydrocarbon polymer contains a chain of carbon atoms, including a plurality of —CH₂—CH₂— groups, which is adherent to the blade, and shows a remarkable increase in shaving effectiveness of the blade. This increase in effectiveness is characterized by a decrease in pull; that is a decrease in the force required to cut the beard hairs, which becomes apparent in the noticeably increased ease of shaving, beard-softening step which precedes shaving. The blades of the present invention, when tested under carefully controlled conditions require much less force to cut water-softened hair off the face than do similar blades without the coatings described herein. The reduction in force required may persist during several successive shaves with the same blade cutting edge, although it does not persist indefinitely.

The drawing is a schematic representation of the razor blade of the present invention.

The solid hydrocarbon polymer coating may extend over the entire wedge faces back from the ultimate edge or even farther, or it may cover only a portion of the final facet.

The hydrocarbon polymers which may be used in are chain of carbon atoms, either linear (straight chain) or branched chain, the linear polymers generally being preferred, including a plurality of —CH₂—CH₂— groups.

Homopolymers of ethylene, as well as copolymers of such as, e.g., propylene or butene, have been found effective, and polymers of butadiene (1,4-addition, also mixed 1,4 and 1,2-addition) when hydrogenated to the extent of about 85% to 90% or more of the theoretical amount also be used as the polymer. Good results have been achieved with both high density and low density polyethylene, including linear, branched, and highly branched polymers, but high-density polyethylene is preferred. The presence of functional groups can enhance bonding of the hydrocarbon to the substrate and improve the coating durability. Preferably, these groups would make up less than 15%, such as, for example, between 0.1% and 15% of the repeat units within the hydrocarbon polymer, and preferably up to 5%. These groups can be added as comonomers to ethylene. In an embodiment the outermost layer comprises ethylene and one or more of the following comonomers: alkenes, acrylates, methacrylates, vinyl anhydrides, vinyl silanes, vinyl phosphonates, and combinations thereof. Additionally, functional groups can also be grafted or obtained by synthesis routes. Examples of these functional groups can include carboxylic acid (sometimes called acrylic) groups, anhydrides, carboxylate esters, carboxylate salts, ketones, aldehydes, alcohols, phosphonate groups, silane groups, methacrylate groups, etc. (Friedrich, Jörg. (2018). Metal-Polymer Systems—Interface Design and Chemical Bonding). In another embodiment, the outermost layer comprises a polyethylene homopolymer which has first undergone an oxidative process, which creates polar groups such as ketones, aldehydes, and carboxylic acids in the polyethylene chain, and results in a polyethylene of lower molecular weight than the starting homopolymer. Mixtures of two or more of any of the foregoing polymers can enhance results. The polymers may vary widely in molecular weight in the form in which they are used for applying to the cutting edge, and good results have been obtained with polymers that have average molecular weights of the order of 5,000 to 25,000, such as, e.g., molecular weights of 10,000, 15,000, 20,000.

It should be noted that while the increased shaving effectiveness of the present invention is obtained by proper curing of a hydrocarbon polymer alone on the blade cutting edge, other materials may be present without having any significant adverse effect upon the shaving effectiveness, Surfactants, dyes, slip agents, some antioxidants and the like may be incorporated in the polymer, for example, and various oils and greases which may or may not contain anticorrosion agents and which are normally applied to the blade may in some cases flow over the outer exposed face of the cured polymer coating. The latter materials are simply wiped off during the handling of the blade or during the first stroke in shaving, leaving the properly cured polymer coating to accomplish the desired result. Other polymers, which are by themselves ineffective for the purpose of the present invention, may be mixed with the hydrocarbon polymers described above in minor proportions without destroying the increase in shaving effectiveness; indeed, in some cases, enhancement of the effect upon shaving characteristics is produced by the addition.

Among polymers which may be thus intermixed with the above-described hydrocarbon polymers are, for example, polyisobutylene, poly (butene-1), poly (4-methylpentene-1), butyl rubber, polypropylene, Hevea rubber, polybutadiene, poly(vinylisobutylether), etc. Polyisobutylene, indeed, may be present in major proportion, as much as 90% (by weight of the mixture) in such a mixture, and its addition in certain proportions produces a noticeable enhancement of shaving effectiveness.

Other additives may also improve the performance of the resulting hydrocarbon polymer film when added in minor amounts (<10% by weight), including internal and external lubricants, adhesion promoters, and crosslinking agents. Examples of internal and external lubricants include fatty acids, such as stearic acid and its metallic salts, hydrocarbons such as paraffin wax, amine waxes, natural waxes such as Montan wax, and other esters. Adhesion promoters can enhance bonding to the substrate and durability of the film during shaving. Examples of adhesion promoters may include organosilanes, organophosphonates, organotitanates, organozirconates, etc Additional examples may be found in the following reference: MICHAEL JAMES OWEN, Chapter 9—Coupling agents: chemical bonding at interfaces, Editor(s): D. A. Dillard, A. V. Pocius, M. Chaudhury, Adhesion Science and Engineering. Crosslinking agents may improve film durability and longevity. Examples include aziridines, isocyanates, melamines, carbodiimides, etc Additional examples may be found in the following reference: Rawlins, James W., Mendon, Sharathkumar K., Polymer Grafting and Crosslinking, pp. 273-318, In Coatings, Adhesives, and Laminates.

In some cases, the film adhesion may be improved by the addition of an interlayer between the hard outer layer and the hydrocarbon layer. The interlayer may consist of a monolayer of a bifunctional molecule having one end group which bonds to the metal oxide substrates, and another which interacts with the hydrocarbon layer. Examples of these materials include, but aren't limited to, organo-silane, organo-phosphonates, organo-titanates, organo-zirconates, etc. The interacting group can be one which interacts with hydrocarbon polymer layer, such as chain of carbon atoms ranging from 1 to 18 carbons, or one which reacts with the hydrocarbon layer or functionalities in the hydrocarbon layer. Examples of the latter include, but aren't limited to, carboxylic/acrylic, amino, vinyl, methacrylate, etc.

The hydrocarbon polymers useful in the present invention can be applied to the blade from a suspension or emulsion of polymer in combination with nonionic surfactants in an aqueous or isopropyl alcohol solvent. The nonionic surfactant may be selected from the group comprising, for example, fatty alcohol ethoxylates, alkyl phenol ethoxylate and fatty acid alkoxylates, polyethylene glycol and polyethylene oxide. Additional examples may be found in the following reference: Hepworth, P. (2006). Non-ionic Surfactants. In Chemistry and Technology of Surfactants, R. J. Farn (Ed.). which may be found at the following website: https://doi.org/10.1002/9780470988596.ch5. They may also be applied from solution in a suitable volatile liquid such as toluene, xylene, decalin, perchloroethylene, dodecane etc. The suspension or emulsion or solution may be deposited on the blade edge by suitable techniques such as spraying, nebulizing, dipping or immersing. The polymers may also be applied directly by melt coating, flame spraying, isostatic press (hot, warm, or cold), etc.

To apply the hydrocarbon polymer suspension/emulsion/solution, the substrate is first heated to a temperature such that, at the time of deposition, it is in the range of about 120° C. to 200° C., preferably between 140° C. and 180° C., more preferably between 145° C. and 165° C.

After application of the polymer to the blade, it is cured by any suitable means to bond it firmly to the substrate and to render it effective for improving the shaving characteristics of the blade. Curing may be induced by heat, radiation, electron beams, chemical additives, or combinations thereof.

The coated blades may be cured, preferably in a non-oxidizing atmosphere (e.g. an inert gas such as nitrogen or argon, or in vacuum) at a temperature between, for example, 150° C. and 500° C., preferably 200° C. to 400° C. for a duration of, for example, 1 to 120 minutes, preferably up to 15 minutes, more preferably 5 minutes.

If the supply of oxygen is restricted, as by heating the coated blades in a partial vacuum or in mixtures of air with inert gases, or if the effect of the oxygen is inhibited by the presence of antioxidants in the polymer coating, longer times or higher temperatures, or both, will be required. It is also possible to shorten the times or decrease the temperatures by introducing into the polymer coating an oxidation catalyst such as cobalt naphthenate.

While the behavior of the polymer coating during the heating or curing step may not be fully understood, it is believed that at least part of the polymer in direct contact with the metal oxide layer undergoes an oxidation reaction resulting in cross-linking, bonding to the metal oxide of the blade surface, and oxidative degradation.

As the oxidation proceeds, the strength of the adherent bond to the cutting edge increases and the physical and chemical structure of the coating gradually changes, reaching optimal properties for shaving purposes at some stage during the oxidation. Further oxidation results in a gradual decrease of the desirable coating properties and finally results in a coating which produces no detectable improvement in shaving characteristics.

Without being held by theory, it is believed that having a blade edge after curing that contains a polymer coating with 10% or more by weight of crystalline material as measured by X-ray diffraction creates a coating that reduces friction and exhibits high durability. The extent of crystallinity for any given coating decreases as the extent of cure increases. The polymer coating can be either amorphous, partially crystalline, or fully crystalline.

The density of the polymer coating is <1.0 g/cm³, such as, e.g., between 0.1 g/cm³ and 0.97 g/cm³, preferably, the density of the polymer coating is between and inclusive of 0.899 to 0.999 g/cm³, more preferably between and inclusive of 0.92 g/cm3 to 0.97 g/cm³.

The resultant thin adherent coating, which is given mechanical support throughout its extent by the underlying blade, reduces the pull during the shaving operation and increases the ease of shaving.

While the coating is applied as one or more layers, it is believed that the coating is thinned during the first several shaves down to a single layer. Without being bound by theory, it is believed that the presence of excess material may increase cutting force during the first several shaves and subsequent removal due to thinning by shaving leads to lower cut forces. It is possible to treat the coating to remove the excess hydrocarbon polymer and reduce cutting force during the first several shaves. This treatment involves immersing the blades in an organic liquid. Preferably, the organic liquid would be raised to a temperature above the melting point of the hydrocarbon polymer (>130° C.) for a period of 1 to 120 minutes, such as, for example, up to 5 minutes, up to 10 minutes, up to 20 minutes, up to 30 minutes, up to 1 hour, such as, for example, between 1 and 10 minutes, between 10 and 20 minutes. Examples of this organic liquid can include for example, mineral oil, acetone, toluene, xylene, decalin, perchloroethylene, dodecaine and combinations thereof. Preferably, the organic liquid is agitated during this process, either via mixing or ultrasonication.

The following specific examples are illustrative of the nature of the present invention. Blades treated in accordance with each of the examples were found by actual shave tests to have remarkably improved shaving characteristics as compared with like blades untreated.

Surface energy may correspond to the cutting force of a cutting member, such as a razor blade. In general, it is desirable to provide a coating material with a relatively low surface energy, while still maintaining a required level of durability to withstand shaving applications.

Surface energies may be determined by a dyne test, in which liquids (e.g., water, diiodomethane, inks, etc.) are applied to a surface and the amount the liquid either spreads out or beads up on the surface is measured for example by measuring the contact angle between the liquid droplet and the surface of the material. For materials with a high surface energy, applied liquid droplets typically spread and form a film on surface of the material. Conversely, for materials with a low surface energy, applied liquid droplets typically form beads.

The coating, including the hydrocarbon polymer coating, may have an aspect ratio (a) to (b), as shown in the inset in FIG. 3, in which (a) is a first thickness 80 from a tip 41 defined by the hydrocarbon polymer coating 60 (defines the outermost layer) to the sharpened tip 40 of the substrate 28, and (b) is a second thickness 82 from an outer surface (not labeled) of the hydrocarbon polymer coating 60 to an underlying surface (not labeled) of the substrate 28. The thickness 82 may be measured at a distance of four micrometers from the sharpened tip 40 (e.g., see distance D₁ in FIG. 8). In some examples, the aspect ratio (a) to (b) may be at least about 1.5:1, at least 2:1, or at least 2.5:1, ±0.5 for (a). In some particular examples, the aspect ratio (a) to (b) may be up to 3.5:1, and in other particular examples, the aspect ratio (a) to (b) may be up to 4:1. In general, a higher aspect ratio translates to a sharper cutting edge and a lower cutting force.
A. A razor blade comprising a sharpened cutting edge comprising a substrate having an outer bonding surface and one or more layers of a coating comprising a hydrocarbon polymer in one or more layers on top of the outer surface, such that the coating material forms an outermost layer of the razor blade.
B. The razor blade of paragraph A, wherein the outermost layer coating is selected from the group comprising polyethylenes.
C. The razor blade of any of paragraphs A to B, wherein the outermost layer coating is selected from the group comprising of high density polyethylene, low density polyethylene, ultrahigh molecular weight polyethylene and mixtures thereof.
D. The razor blade of any of paragraphs A to C, wherein the outermost layer coating is a homopolymer polyethylene.
E. The razor blade of paragraph B to D, wherein the outermost layer coating is selected from the group of polyethylene copolymers comprising ethylene and one or more comonomers.
F. The razor blade of any of paragraphs B to E, wherein the coating material comprises a polyethylene homopolymer or polyethylene copolymer with one or more functional groups.
G. The razor blade of any of paragraphs B to F, wherein the outermost layer coating is selected from the group comprising polyethylene and one or more of the following comonomers: alkenes, acrylates, methacrylates, vinyl anhydrides, vinyl silanes, vinyl phosphonates, and any combinations thereof.
H. The razor blade of any of paragraphs A to G, wherein the outermost layer coating is selected from the group consisting of polyethylene.
I. The razor blade of any of paragraphs A to H, wherein the hydrocarbon polymer of the coating material comprises one or more functional groups.
J. The razor blade of paragraph I, wherein the one or more functional groups are selected from the list comprising of carboxylic acids, anhydrides, carboxylate esters, carboxylate salts, ketones, aldehydes, alcohols, phosphonate groups, silane groups, and mixtures thereof.
K. The razor blade of any of paragraphs I to J, wherein the one or more functional groups are carboxylic acids.
L. The razor blade of any of paragraphs I to K, wherein the functional groups make up to 15% of the repeat units within the hydrocarbon polymer.
M. The razor blade of any of paragraphs A to L, wherein the razor blade comprises a substrate comprising a metal.
N. The razor blade of any of paragraphs A to M, wherein the percentage of the substrate surface area in the first 300 micrometers as measured from the blade tip covered by the hydrocarbon polymer is greater than 30%.
O. The razor blade of any of paragraphs A to N, wherein the substrate has a tip and wherein the substrate has a thickness of between 2 and 10 micrometers at a distance of 10 micrometers from the tip and a thickness of between 20 and 45 micrometers at a distance of 150 micrometers from the tip.
P. The razor blade of any of paragraphs A to O, wherein the substrate has (a) a first thickness from a tip defined by the hydrocarbon polymer coating to a tip of the substrate, and (b) a second thickness from an outer surface of the hydrocarbon polymer coating to an underlying surface of the substrate;
   wherein the aspect ratio (a) to (b) may be at least about 1.5:1.
Q. The razor blade of any of paragraphs A to P, wherein the hydrocarbon polymer coating material forms a layer that is less than 1 micron thick.
R. The razor blade of any of paragraphs A to Q, wherein the substrate comprises an outer surface bonding layer between the substrate and the hydrocarbon polymer coating.
S. The razor blade of any of paragraphs A to R, further comprising at least one additional layer of material disposed between the sharpened cutting edge and the hydrocarbon polymer coating material, wherein at least one additional layer of material subjacent to the hydrocarbon polymer coating material defines the outer bonding surface.
T. The razor blade of paragraph S, wherein the at least one additional layer of material comprises one or more of: (i) diamond, amorphous diamond, or diamond-like-carbon (DLC); or (ii) chromium, platinum, boron, chromium diboride, titanium, titanium diboride, vanadium, aluminum, silicon, magnesium, manganese, iron, cobalt, nickel, copper, silver, zinc, tin, hafnium, tantalum, tungsten, zirconium, molybdenum, or niobium, and oxides, nitrides, oxynitrides, and borides thereof.
AA. A method of depositing a hydrocarbon polymer layer onto the outer layer of a substrate, the method comprising:
   providing a substrate,
   depositing a hydrocarbon polymer layer onto the substrate to create a coated substrate, curing the hydrocarbon polymer layer on the coated substrate.
BB. The method of paragraph AA, wherein curing the hydrocarbon polymer cures the polymer to exhibit at least 10% crystallinity.
CC. The method of any of paragraphs AA to BB, wherein curing is done in a non-oxidizing atmosphere at a temperature between 150° C. and 500° C.
DD. The method of any of paragraphs AA to CC, wherein curing is done for a duration for a duration of 1 to 120 minutes.
EE. The method of any of paragraphs AA to DD, wherein the hydrocarbon polymer layer comprises one or more functional groups that are selected from the list comprising carboxylic acid (sometimes called acrylic) groups, anhydrides, carboxylate esters, carboxylate salts, ketones, aldehydes, alcohols, phosphonate groups, silane groups, methacrylate groups, and mixtures thereof.
FF. The method of paragraph EE, wherein one or more functional groups are carboxylic acids.
GG. The method of any of paragraphs AA to FF, wherein the cured hydrocarbon polymer exhibits a density between 0.1 g/cm³ and 1.0 g/cm³.
HH. The method of any of paragraphs AA to GG, wherein The step of depositing a hydrocarbon polymers to the substrate is in the form of a suspension or emulsion of polymer in combination with nonionic surfactants in an aqueous or isopropyl alcohol solvent.
II. The method of any of paragraphs AA to HH, wherein the hydrocarbon polymers are deposited on the substrate by any of spraying, nebulizing, dipping or immersing, melt coating, flame spraying, isostatic press (hot, warm, or cold), or combinations thereof.
JJ. The method of any of paragraphs AA to II, wherein the method further comprises heating the substrate prior to the deposition to a temperature between about 120° C. to 200° C.
KK. The method of any of paragraphs AA to JJ, wherein depositing a hydrocarbon polymers to the substrate in the form of a suspension or emulsion of polymer in combination with nonionic surfactants in an aqueous or isopropyl alcohol solvent.
LL. The method of any of paragraphs AA to KK, wherein the hydrocarbon polymers are deposited on the substrate by spraying, nebulizing, dipping or immersing. The polymers may also be applied directly by melt coating, flame spraying, isostatic press (hot, warm, or cold), etc.
MM. The method of any of paragraphs AA to LL, wherein the method further comprises heating the substrate prior to the deposition to a temperature such that, at the time of deposition, it is in the range of about 120° C. to 200° C., preferably between 140° C. and 180° C., more preferably between 145° C. and 165° C.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor blade comprising a sharpened cutting edge comprising a substrate having an outer bonding surface and one or more layers of a coating comprising a hydrocarbon polymer in one or more layers on top of the outer surface, such that the coating material forms an outermost layer of the razor blade.

2. The razor blade of claim 1, wherein the outermost layer coating is selected from the group comprising polyethylenes.

3. The razor blade of claim 1, wherein the outermost layer coating is selected from the group comprising of high density polyethylene, low density polyethylene, ultrahigh molecular weight polyethylene and mixtures thereof.

4. The razor blade of claim 1, wherein the outermost layer coating is a homopolymer polyethylene.

5. The razor blade of claim 2, wherein the outermost layer coating is selected from the group of polyethylene copolymers comprising ethylene and one or more comonomers.

6. The razor blade of claim 2, wherein the coating material comprises a polyethylene homopolymer or polyethylene copolymer with one or more functional groups.

7. The razor blade of claim 2, wherein the outermost coating is selected from the group comprising polyethylene and one or more of the following comonomers: alkenes, acrylates, methacrylates, vinyl anhydrides, vinyl silanes, vinyl phosphonates, and any combinations thereof.

8. The razor blade of claim 1, wherein the outermost layer coating is selected from the group consisting of polyethylene.

9. The razor blade of claim 1, wherein the hydrocarbon polymer of the coating material comprises one or more functional groups.

10. The razor blade of claim 9, wherein the one or more functional groups are selected from the list comprising of carboxylic acids, anhydrides, carboxylate esters, carboxylate salts, ketones, aldehydes, alcohols, phosphonate groups, silane groups, and mixtures thereof.

11. The razor blade of claim 9, wherein the one or more functional groups are carboxylic acids.

12. The razor blade of claim 9, wherein the functional groups make up to 15% of the repeat units within the hydrocarbon polymer.

13. The razor blade of claim 1, wherein the razor blade comprises a substrate comprising a metal.

14. The razor blade of claim 1, wherein the percentage of the substrate surface area in the first 300 micrometers as measured from the blade tip covered by the hydrocarbon polymer is greater than 30%.

15. The razor blade of claim 1, wherein the substrate has a tip and wherein the substrate has a thickness of between 2 and 10 micrometers at a distance of 10 micrometers from the tip and a thickness of between 20 and 45 micrometers at a distance of 150 micrometers from the tip.

16. The razor blade of claim 1, wherein the substrate has (a) a first thickness from a tip defined by the hydrocarbon polymer coating to a tip of the substrate, and (b) a second thickness from an outer surface of the hydrocarbon polymer coating to an underlying surface of the substrate;
wherein the aspect ratio (a) to (b) may be at least about 1.5:1.

17. The razor blade of claim 1, wherein the hydrocarbon polymer coating material forms a layer that is less than 1 micron thick.

18. The razor blade of claim 1, wherein the substrate comprises a bonding layer between the substrate and the hydrocarbon polymer coating.

19. The razor blade of claim 1, further comprising at least one additional layer of material disposed between the sharpened cutting edge and the hydrocarbon polymer coating material, wherein at least one additional layer of material subjacent to the hydrocarbon polymer coating material defines the outer bonding surface.

20. The razor blade of claim 19, wherein the at least one additional layer of material comprises one or more of: (i) diamond, amorphous diamond, or diamond-like-carbon (DLC); or (ii) chromium, platinum, boron, chromium diboride, titanium, titanium diboride, vanadium, aluminum, silicon, magnesium, manganese, iron, cobalt, nickel, copper, silver, zinc, tin, hafnium, tantalum, tungsten, zirconium, molybdenum, or niobium, and oxides, nitrides, oxynitrides, and borides thereof.
